(19) United States
(12) Patent Application Publication
(10) Pub. No.: US 2026/0270598 A1
(43) Pub. Date: Sep. 10, 2026

(54) MULTIPLE-SENSOR DIE ARRANGEMENT

(71) Applicant: TDK U.S.A Corporation, Uniondale, NY (US)

(72) Inventors: Jeremy Parker, Chelmsford, MA (US); Sushil Bharatan, Burlington, MA (US)

(21) Appl. No.: 19/548,620

(22) Filed: Feb. 24, 2026

Related U.S. Application Data
(60) Provisional application No. 63/769,693, filed on Mar. 10, 2025.

(51) Int. Cl. H04R 1/04; H04R 1/06; H04R 19/02; H04R 29/00

(52) U.S. Cl. CPC H04R 1/04; H04R 1/06; H04R 29/005; H04R 19/02; H04R 2201/003

(57) ABSTRACT

A sensor component can comprise a multi-sensor element arrangement comprising multiple sensor elements on a single die that can be attached to a top layer of a multi-layer component. The sensor elements can be associated with one or more ASICs on the top layer of the sensor component, and the ASIC(s) can be associated with other layers, including conductive terminals of the bottom layer, of the multi-layer component. The sensor component can be associated with a common bus, and the sensor elements and/or ASIC(s) can be respectively and individually addressed, configured, and/or controlled based on respective address, configuration, control, and/or other signals that can be received by the sensor component via the common bus. The sensor component can have a larger sound port and larger back volume that can be shared by the sensor elements to enhance acoustic performance.

### CROSS-REFERENCE TO RELATED APPLICATION

This application claims priority to U.S. Provisional Patent Application Ser. No. 63/769,693, filed on Mar. 10, 2025, and entitled “Digital MEMS Microphone Array,” the entirety of which application is hereby incorporated by reference herein.

### TECHNICAL FIELD

The subject disclosure relates generally to sensor technology, e.g., techniques for a multiple-sensor die arrangement.

### BACKGROUND

A sensor can be employed to sense conditions associated with or in proximity to the sensor. A sensor package can comprise the sensor, which can be associated with various electronic components that can be utilized to facilitate operation of the sensor.

The above-described description is merely intended to provide a contextual overview relating to sensor technology, and is not intended to be exhaustive.

### SUMMARY

The following presents a simplified summary of various aspects of the disclosed subject matter in order to provide a basic understanding of some aspects described herein. This summary is not an extensive overview of the disclosed subject matter. It is intended to neither identify key or critical elements of the disclosed subject matter nor delineate the scope of such aspects. Its sole purpose is to present some concepts of the disclosed subject matter in a simplified form as a prelude to the more detailed description that is presented later.

In some embodiments, the disclosed subject matter can comprise a system that can comprise a group of sensor elements that can comprise respective sensor elements that can be formed on a single semiconductor die, wherein the group of sensor elements can be configured to sense a condition. The system also can include a group of integrated circuits that can comprise respective integrated circuits that can be configured to be associated with the respective sensor elements, wherein the respective integrated circuits, and the respective sensor elements via the respective integrated circuits, can be configured to be associated with a single common bus.

In certain embodiments, the disclosed subject matter can comprise a sensor device comprising a group of sensor elements that can comprise respective sensor elements that can be contained on a single semiconductor die, wherein the group of sensor elements can be configured to sense a condition. The sensor device also can comprise at least one application-specific integrated circuit (ASIC) that can be configured to be associated with the respective sensor elements, wherein the at least one ASIC and the respective sensor elements, via the at least one ASIC, can be configured to be associated with a single common bus.

In some embodiments, the disclosed subject matter can comprise a system comprising a group of sensor elements that can comprise respective sensor elements that can be contained on a single die, wherein the respective sensor elements can be structured to form a multiple-dimensional array of sensor elements, and wherein the group of sensor elements can be configured to sense a condition. The system also can include at least one ASIC that can be configured to be associated with the respective sensor elements, wherein the at least one ASIC and the respective sensor elements, via the at least one ASIC, can be configured to be associated with a single common bus.

The following description and the annexed drawings set forth in detail certain illustrative aspects of the disclosed subject matter. These aspects are indicative, however, of but a few of the various ways in which the principles of the disclosed subject matter may be employed, and the disclosed subject matter is intended to include all such aspects and their equivalents. Other advantages and distinctive features of the disclosed subject matter will become apparent from the following detailed description of the disclosed subject matter when considered in conjunction with the drawings.

### BRIEF DESCRIPTION OF THE DRAWINGS

FIG. 1 illustrates a block diagram of an example system that can comprise a sensor component that can desirably comprise a multi-sensor element arrangement comprising multiple sensor elements on a single die, in accordance with various aspects and embodiments of the disclosed subject matter.

FIG. 2 depicts a diagram of a non-limiting example sensor component that can comprise a first (e.g., top) layer (e.g., an inside top view of the first layer) of a multi-layer component of the sensor component, the first layer comprising respective sensor elements of a group of sensor elements formed, located, arranged, or contained on a single die and respective ASICs associated with the respective sensor elements, in accordance with various aspects and embodiments of the disclosed subject matter.

FIG. 3 depicts diagrams of a second (e.g., bottom) layer (e.g., an outside bottom view of the second layer), comprising respective terminals, of the multi-layer component of the sensor component, and a lid component (e.g., an outside top view of the lid component) of the sensor component, in accordance with various aspects and embodiments of the disclosed subject matter.

FIG. 4 illustrates a diagram of a non-limiting example system that can desirably comprise a multi-sensor element arrangement comprising multiple sensor elements on a single die, wherein the sensor elements and associated circuitry (e.g., ASICs) can be associated with a common bus and an application, in accordance with various aspects and embodiments of the disclosed subject matter.

FIG. 5 depicts a diagram of non-limiting example system that can comprise a sensor component that can desirably comprise a multi-sensor element arrangement comprising multiple sensor elements on a single die, and an electronic circuit (e.g., an ASIC) that can be associated with the sensor elements, in accordance with various aspects and embodiments of the disclosed subject matter.

FIG. 6 depicts a diagram of non-limiting example system that can be utilized to create sensor components that each can comprise a multi-sensor element arrangement comprising multiple sensor elements on a single die, in accordance with various aspects and embodiments of the disclosed subject matter.

FIG. 7 illustrates a diagram of a non-limiting example semiconductor wafer that can comprise sensor elements that can be diced into respective groups (e.g., arrays) of sensor elements on respective single dies, in accordance with various aspects and embodiments of the disclosed subject matter.

FIG. 8 depicts a flow diagram of an example method that can desirably comprise a multi-sensor element arrangement comprising multiple sensor elements on a single die, in accordance with various aspects and embodiments of the disclosed subject matter.

### DETAILED DESCRIPTION

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein.

This disclosure relates to multiple-sensor die arrangements. Various types of sensors can be utilized to sense various types of conditions. For instance, some sensors, such as microphones, can sense sounds (e.g., sense audio or sound waves). Certain types of existing microphones, such as certain existing Microelectromechanical Systems (MEMS) microphones, can have undesirable performance limitations, including a single undesirably small-diameter sound port and an undesirably small back volume (e.g., cavity), due to packaging constraints. Also, with existing MEMS microphones, a high-frequency acoustic overload point (AOP) can be directly impacted by a position of a resonant peak of the typical MEMS microphone, which very often can be underdamped and/or have a high quality (Q) factor (high-Q). For every decibel (dB) above the 1 kilohertz (kHz) sensitivity point that the resonant peak rises, the AOP at that frequency can be directly reduced.

Some existing MEMS microphones can have a single MEMS microphone element (e.g., single microphone element comprising a diaphragm and a backplate) on a single semiconductor die paired with a single application-specific integrated circuit (ASIC). Such existing MEMS microphones with single MEMS microphone elements can have the aforementioned deficiencies and performance limitations, including a single undesirably small-diameter sound port and an undesirably small back volume.

To overcome the various issues and deficiencies of existing systems, methods, and techniques relating to sensors, the disclosed subject matter can employ techniques, systems, devices, and methods that can comprise or create a sensor component that can desirably (e.g., suitably, efficiently, reliably, in an enhanced manner, and/or optimally) comprise a multiple (multi)-sensor element arrangement comprising multiple sensor elements on a single semiconductor die, in accordance with various aspects and embodiments. In some embodiments, a system or device can comprise a sensor component that can sense a condition(s) (e.g., pressure (e.g., sound pressure), motion, or other type of condition) in proximity to the sensor component. In certain embodiments, the sensor component can comprise a group of sensor elements that can be formed on a single die (e.g., the sensor elements can be contiguous, unseparated, or not diced with respect to each other, and can be in the form of a multi-sensor element array). In accordance with various embodiments, the sensor elements of the sensor component can sense, detect, and/or measure conditions associated with (e.g., in proximity to) the sensor component. In some embodiments, the sensor elements can be microphone elements (e.g., MEMS microphone elements or other type of microphone elements) that can sense, detect, and/or measure sounds (e.g., sound pressure levels (SPLs), amplitudes, and/or other conditions or qualities of sound waves) in proximity to the sensor component. In some embodiments, the sensor component can comprise or can be associated with one or more electronic circuits, such as one or more ASICs or other electronic circuits, that can comprise various electronic components (e.g., resistors, capacitors, switches, switched capacitor resistors (SCRs), transistors, diodes, and/or other electronic components) that can perform respective functions.

In some embodiments, the sensor component can comprise a multi-layer component that can comprise a top layer, one or more middle layers, and a bottom layer. In certain embodiments, the single die, comprising the group of sensor elements, can be attached (e.g., bonded) to the top layer of the multi-layer component. In some embodiments, the sensor elements can be associated with the one or more ASICs that can be formed on or attached to the top layer of the sensor component, and the ASIC(s) can be associated with (e.g., electronically and/or communicatively connected to) the other layers, including conductive terminals of the bottom layer, of the multi-layer component (e.g., using conductive via interconnects that can span across the layers of the multi-layer component). In certain embodiments, the respective conductive terminals on the bottom layer can comprise one or more data terminals, a power terminal, one or more clock terminals, a ground terminal, and/or one or more other types of terminals.

In some embodiments, the sensor component can comprise and/or can be associated with a common bus that can be associated with the conductive terminals of the bottom layer of the multi-layer component. In certain embodiments, the common bus can comprise a data bus, control bus, address bus, power bus, clock bus, ground bus, and/or other desired bus. In certain embodiments, the data bus(es) can enable communication of data, control signals, and/or address signals (e.g., address information for addressing, selecting, and/or configuring respective sensor elements) between the sensor component and the application, other system (or other part of the system), and/or device (and accordingly, the common bus may or may not have a separate address bus or separate control bus). In accordance with various embodiments, the common bus also can be associated with (e.g., electronically and/or communicatively connected to) an application, another system (or another part of the system comprising the sensor component), a device, and/or a user (e.g., customer or other user that can use the application, the other system (or the system), and/or the device). In accordance with various embodiments, the sensor elements and/or ASIC(s) can be respectively and individually addressed, configured, and/or controlled based at least in part on respective address signals, configuration signals, control signals, clock signals, and/or other signals that can be received by the sensor component via the common bus from the application, other system (or other part of the system), device, and/or user.

In accordance with various embodiments, the respective sensor elements and/or the respective ASIC(s) of the sensor component can be individually and respectively addressed (e.g., individually and respectively selected and/or set based at least in part on their respective addresses), configured (e.g., respective parameters or settings can be configured), and/or controlled, based at least in part on the respective signals (e.g., respective address signals, configuration signals, control signals, clock signals, and/or other signals), to sum and correlate the signals (e.g., sensor or audio signals) of two or more sensor elements together, to configure or set respective voltage biases and/or other parameters for the respective sensor elements, to respectively and uniquely trim and/or set the sensitivities of respective sensor elements and/or ASICs to cover respective ranges of SPLs, to achieve desired beamforming of the respective sensor elements, to achieve desired dynamic range extension of the respective sensor elements, to perform an acoustic self-test of the sensor elements, to respectively configure and/or control the respective sensor elements and/or the respective ASICs for other desired purposes, and/or to achieve other desired functionality and operation of the respective sensor elements and/or ASICs, such as described herein. Such flexibility and functionality of the sensor component, and in the processing of individual signals of the respective sensor elements, can enable the sensor component to provide enhanced (e.g., improved, increased, and/or optimized) sensor and/or acoustic performance, as compared to existing sensors, such as described herein.

In accordance with various embodiments, the sensor component can have a larger sound port and larger back volume (e.g., as compared to existing sensors) that can be shared by the sensor elements, which can enhance (e.g., improve, increase, and/or optimize) acoustic performance of the sensor component, as compared to existing sensors.

These and other aspects of the disclosed subject matter are described with regard to the figures.

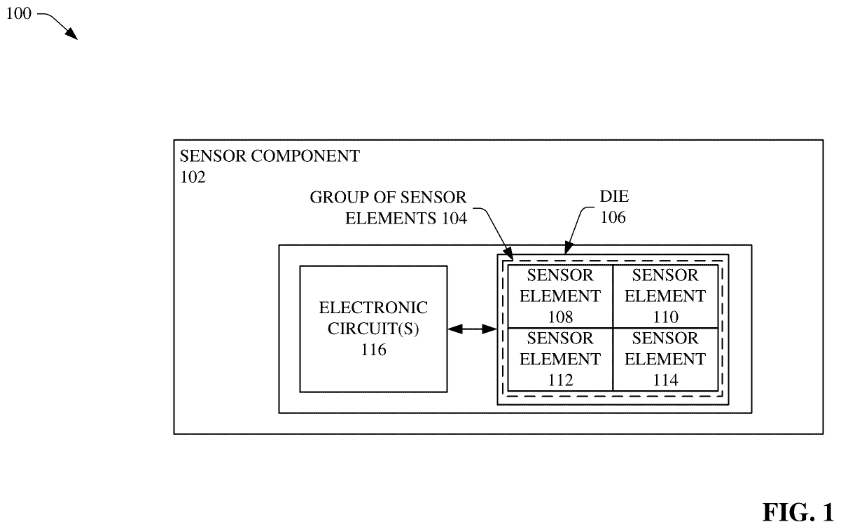

Turning to FIG. 1, illustrated is a block diagram of an example system 100 that can comprise a sensor component that can desirably (e.g., suitably, efficiently, reliably, in an enhanced manner, and/or optimally) comprise a multi-sensor element arrangement comprising multiple sensor elements on a single die, in accordance with various aspects and embodiments of the disclosed subject matter. In some embodiments, the system 100 can comprise a sensor component 102 that can comprise a group of sensor elements 104, which can comprise two or more sensor elements, formed, located, arranged, or contained on a single die 106 (e.g., single semiconductor die). In certain embodiments, the group of sensor elements 104 can comprise four sensor elements, including sensor element 108, sensor element 110, sensor element 112, and sensor element 114, contained on the die 106 in the form of a sensor element array (e.g., a 2×2 sensor element array). In other embodiments, the group of sensor elements 104 can comprise more than four sensor elements contained on the die 106 in the form of a sensor element array (e.g., a 3×3 sensor element array, a 4×4 sensor element array, or other a n×n or n×m sensor element array, wherein n and m each can be a respective desired integer number).

In some embodiments, the respective sensor elements of the group of sensor elements 104 can be connected to and/or contiguous with respect to each other on the single die. For instance, with regard to a larger group of sensor elements formed on a semiconductor wafer, the semiconductor wafer comprising the larger group of sensor elements can be diced (e.g., cut, divided, or split) into respective dies that can comprise respective groups of sensor elements (e.g., respective groups of multiple sensor elements), comprising the group of sensor elements 104. As a result, the respective sensor elements (e.g., sensor elements 108, 110, 112, and/or 114) of the group of sensor elements 104 can be part of the single die 106. In certain embodiments, by having the respective sensor elements 108, 110, 112, and/or 114 on the single die 106, the respective sensor elements 108, 110, 112, and/or 114 can utilize less space (e.g., a smaller amount of space or area) in the sensor package of the sensor component 102 (and less space on the layer to which the single die 106 can be attached or bonded to) than the amount of space utilized by existing sensors in existing sensor packages where the existing sensors can be separate from each other (e.g., existing sensors can be on separate dies).

In accordance with various embodiments, all or a portion of the system 100 can be part of a device (e.g., electronic and/or communication device). In some embodiments, the sensor component 102 can be, or can be part of, the device. In accordance with various embodiments, the group of sensor elements 104 can be, can comprise, or can be part of one or more of a microphone, a sound pressure sensor, a MEMS sensor, a pressure sensor, an acoustic sensor, a capacitive sensor, a piezo sensor, and/or other type of sensor. In some embodiments, the sensor component 102, employing the group of sensor elements 104, can sense a condition(s) (e.g., pressure (e.g., sound pressure and/or other pressure), motion, and/or other type of condition) in proximity to the sensor component 102.

In some embodiments, the respective sensor elements (e.g., sensor elements 108, 110, 112, and/or 114) of the group of sensor elements 104 can be associated with (e.g., electronically and/or communicatively connected to) at least one electronic circuit, such as electronic circuit 116 (e.g., integrated circuit(s) (IC(s)) or ASIC(s)). In certain embodiments, the respective sensor elements (e.g., sensor elements 108, 110, 112, and/or 114) of the group of sensor elements 104 can be associated with (e.g., electronically and/or communicatively connected to) respective electronic circuits (e.g., a first sensor element associated with a first ASIC, second sensor element associated with a second ASIC, and/or another sensor element(s) associated with another ASIC(s)). In certain other embodiments, the respective sensor elements (e.g., sensor elements 108, 110, 112, and/or 114) of the group of sensor elements 104 can be associated with (e.g., electronically and/or communicatively connected to) one or more electronic circuits, wherein the number of electronic circuits (e.g., ASICs) can be different from the number of sensor elements. In accordance with various embodiments, the at least one electronic circuit (e.g., the electronic circuit(s) 116) can comprise various components that can comprise, for example, capacitors, resistors, switches, SCRs, transistors, inductors, diodes, electronic or conductive connectors, conductive terminals or pads, and/or other associated components and circuitry that can be respectively arranged and/or associated with (e.g., connected to) each other to form desired circuitry of the sensor component 102. In certain embodiments, such various components also can comprise a processor component (e.g., microcontroller, microprocessor, controller, processor, and/or other type of processing unit) and/or a data store or memory component, which can comprise volatile and/or non-volatile memory, such as described herein.

In some embodiments, the group of sensor elements 104 and the at least one electronic circuit (e.g., electronic circuit(s) 116) can be part of a multi-layer component that can comprise a desired number of respective layers and respective electronic components and circuitry that can be part of or associated with the respective layers, wherein the respective layers can comprise non-conductive material(s), semiconductor material(s), and/or conductive material(s), such as described herein. In certain embodiments, the sensor component 102 can comprise or can be associated with a common bus that can be utilized to communicate signals (e.g., data signals, control signals, clock signals, and/or other signals), and/or to provide power and/or a ground to the sensor component 102, such as described herein.

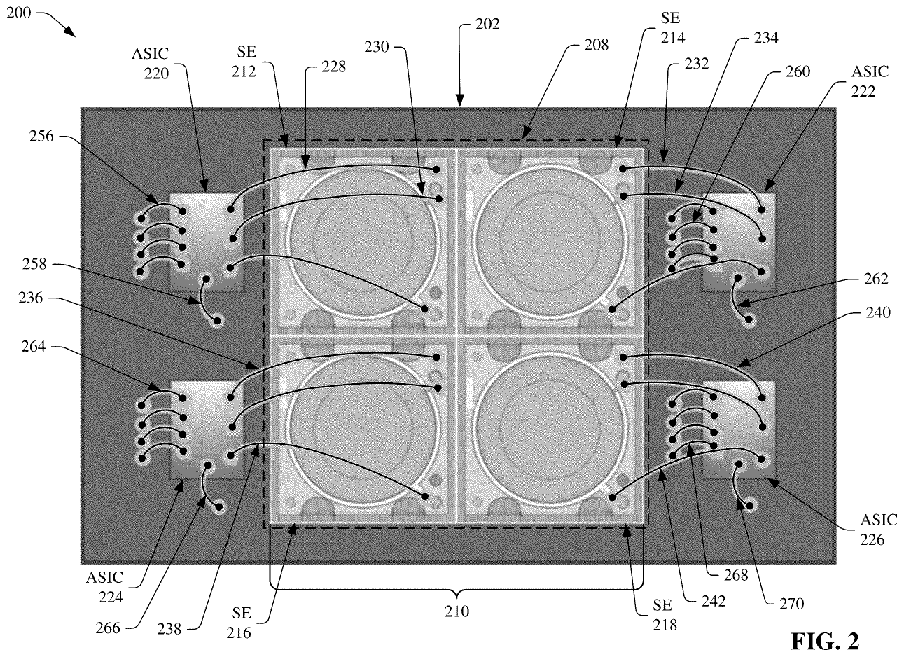

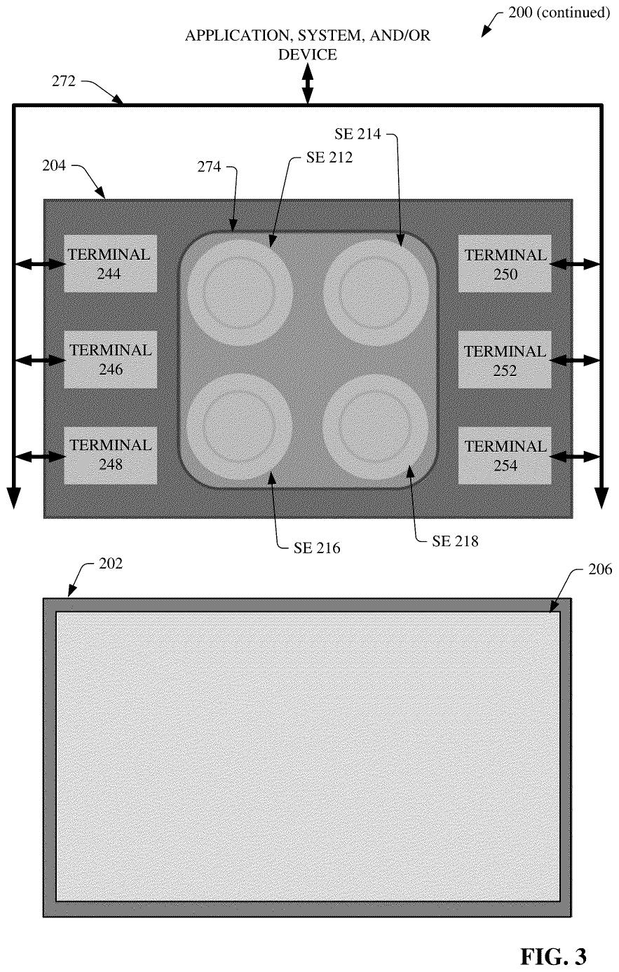

Referring to FIGS. 2 and 3 (along with FIG. 1), FIG. 2 depicts a diagram of a non-limiting example sensor component 200 that can comprise a first (e.g., top) layer 202 (e.g., an inside top view of the first layer 202) of a multi-layer component of the sensor component 200, the first layer 202 comprising respective sensor elements of a group of sensor elements formed, located, arranged, or contained on a single die and respective ASICs associated with the respective sensor elements, and FIG. 3 depicts diagrams of a second (e.g., bottom) layer 204 (e.g., an outside bottom view of the second layer 204), comprising respective terminals, of the multi-layer component of the sensor component 200, and a lid component 206 (e.g., an outside top view of the lid component 206) of the sensor component 200, in accordance with various aspects and embodiments of the disclosed subject matter. In certain embodiments, the sensor component 200 can be same as or similar to, and/or can comprise the same or similar functionality as, the sensor component 102 of the system 100. In some embodiments, the sensor component 200 can comprise the multi-layer component that can comprise a desired number of layers of materials (e.g., laminate, dielectric, insulating, conductive, and/or semiconductor materials) that can be arranged in relation to each other as a stack of layers, wherein the respective layers can have a desired size and shape (e.g., desired length, width, and thickness; and/or square, rectangular, or other shape). For instance, the multi-layer component can comprise the first layer 202, the second layer 204, and/or one or more other (e.g., middle, intermediate, or inner) layers (not shown in FIG. 2) that can be situated in between the first layer 202 and the second layer 204, wherein the one or more other layers can comprise a dielectric and/or non-conductive material(s), semiconductor material(s), and/or a conductive material(s).

In certain embodiments, the multi-layer component can comprise respective layers that respectively can be used for signals (e.g., data signals and/or control signals), ground, power, and/or another desired purpose (e.g., a layer that can be employed as a signal plane to facilitate generation and/or communication of signals for the sensor component 200, another layer that can be employed as a ground plane to provide a ground for the sensor component 200, another layer that can be employed as a power plane to provide power for the sensor component 200, and/or yet another layer that can be employed as another type of plane for the sensor component 200). In accordance with various embodiments, the multi-layer component can comprise fiberglass-reinforced epoxy laminate (e.g., FR-4 or other fiberglass-reinforced epoxy laminate), teflon material (e.g., polytetrafluoroethylene (PTFE) material), conductive materials (e.g., copper, silver, gold, and/or other conductive material), and/or other desired materials.

In some embodiments, the first (e.g., top) layer 202 of the multi-layer component of the sensor component 200 can comprise a dielectric and/or non-conductive material(s) of a desired size and shape (e.g., desired length, width, and thickness; and/or square, rectangular, or other shape). In certain embodiments, a single die 208 can comprise a group of sensor elements 210 that can comprise four sensor elements, including sensor element (SE) 212, sensor element 214, sensor element 216, and sensor element 218 (e.g., in the form of a sensor element array (e.g., a 2×2 sensor element array)), and the single die 208 (e.g., single semiconductor die) can be associated with (e.g., attached or bonded to) the first layer 202 (e.g., the top or outfacing surface of the first layer 202). In some embodiments, the respective sensor elements (e.g., sensor elements 212, 214, 216, and 218) of the group of sensor elements 210 can be connected to (e.g., not diced or separated from each other) and/or contiguous with respect to each other on the single die 208, such as described herein. In certain embodiments, the respective sensor elements (e.g., sensor elements 212, 214, 216, and 218) can comprise respective diaphragms, respective backplates, and/or other respective components to enable sensing functionality of the respective sensor elements (e.g., the respective sensor elements can be respective microphones that can sense conditions, such as sound waves and/or sound pressure, associated with or in proximity to the respective sensor elements).

In some embodiments, respective ASICs, comprising ASIC 220, ASIC 222, ASIC 224, and ASIC 226, can be associated with (e.g., attached or bonded to) the first layer 202 (e.g., the top or outfacing surface of the first layer 202) in proximity to the respective sensor elements 212, 214, 216, and 218, and can be associated with (e.g., connected or wirebonded to) the respective sensor elements 212, 214, 216, and 218. For instance, respective terminals (e.g., conductive terminals) of the ASIC 220 can be connected to respective terminals (e.g., conductive terminals) of the sensor element 212 via respective wirebonds, including wirebond 228, wirebond 230, and/or other desired wirebonds, respective terminals of the ASIC 222 can be connected to respective terminals of the sensor element 214 via respective wirebonds, comprising wirebond 232, wirebond 234, and/or other desired wirebonds, respective terminals of the ASIC 224 can be connected to respective terminals of the sensor element 216 via respective wirebonds, including wirebond 236, wirebond 238, and/or other desired wirebonds, and respective terminals of the ASIC 226 can be connected to respective terminals of the sensor element 218 via respective wirebonds, comprising wirebond 240, wirebond 242, and/or other desired wirebonds.

In certain embodiments, the respective sensor elements (e.g., sensor elements 212, 214, 216, and 218, which can be, for example, MEMS microphone elements) and the respective ASICs (e.g., ASICs 220, 222, 224, and 226) can utilize the same amount of area of the first layer 202 as a single sensor element and associated ASIC (e.g., an existing single sensor element and associated ASIC) would utilize, without having to utilize a different layout on the first layer 202 than the single sensor element and associated ASIC would utilize. This can be due, in part, to having the respective sensor elements 212, 214, 216, and 218 (e.g., an array of four (or more) sensor elements) on a single die, such as described herein. As a result, there does not have to be additional development of the layout and/or design of the first layer 202 (or the other layers of the multi-layer component) and/or ASICs in order to increase the number of sensor elements on the first layer 202 to have two, four, eight, or other desired number of sensor elements on the first layer 202. Further, the sensor component 200 can provide enhanced (e.g., improved, increased, higher, and/or optimized) performance for a given sensor package size, and can have fewer individual packages (e.g., can have less individual sensor element dies and/or other component packages) to populate on the layer (e.g., to populate on-printed circuit board (PCB)), as compared to existing sensors.

In certain embodiments, the respective ASICs (e.g., ASICs 220, 222, 224, and 226) can be connected to respective conductive via interconnects that can be formed in or associated with respective vias that can be formed in (e.g., drilled in) the first layer 202 to facilitate connecting the respective ASICs to respective conductive terminals (e.g., conductive pads), which can comprise conductive terminals 244, 246, 248, 250, 252, and/or 254, formed on the second layer 204 (e.g., the bottom or outfacing surface of the second layer 204), wherein such connections between the respective ASICs and the respective conductive terminals can comprise direct connections to one or more of the conductive terminals, or indirect connections to one or more the conductive terminal via one or more electronic circuits of one or more middle layers of the multi-layer component. For instance, respective terminals of the ASIC 220 can be connected to respective conductive via interconnects using respective wirebonds, including wirebond 256, wirebond 258, and/or one or more other wirebonds, respective terminals of the ASIC 222 can be connected to respective conductive via interconnects using respective wirebonds, comprising wirebond 260, wirebond 262, and/or one or more other wirebonds, respective terminals of the ASIC 224 can be connected to respective conductive via interconnects using respective wirebonds, including wirebond 264, wirebond 266, and/or one or more other wirebonds, and respective terminals of the ASIC 226 can be connected to respective conductive via interconnects using respective wirebonds, comprising wirebond 268, wirebond 270, and/or one or more other wirebonds, to facilitate respective connections between the respective ASICs and the respective conductive terminals 244, 246, 248, 250, 252, and/or 254 formed on the second layer 204. In some embodiments, the respective conductive via interconnects can be connected to an electronic circuit(s) of a middle layer(s) of the multi-layer component and/or to a conductive terminal(s) (e.g., 244, 246, 248, 250, 252, and/or 254) of the second layer 204.

In accordance with various embodiments, the respective conductive terminals 244, 246, 248, 250, 252, and/or 254 can be shared by the group of sensor elements 210 (e.g., the respective sensor elements 212, 214, 216, and 218) of the sensor component 200, and can facilitate performance of respective functions to facilitate operation of the sensor component 200. For example, the respective conductive terminals 244, 246, 248, 250, 252, and/or 254 can comprise a power terminal, one or more clock terminals, one or more data terminals, a ground terminal, and/or one or more other types of terminals, wherein the power terminal can enable power to be provided to the sensor component 200 (e.g., to the respective sensor elements of the sensor component 200), the one or more clocks terminals can enable one or more clock signals to be provided to the components (e.g., including the respective sensor elements) of the sensor component 200, the one or more data terminals can enable data and/or control signals to be communicated to or from the sensor component 200 (e.g., to or from the respective sensor elements of the sensor component 200; and from or to a device, system, or application), and the ground terminal can enable the sensor component 200 to be desirably grounded to a ground associated with the ground terminal.

In some embodiments, the respective conductive terminals 244, 246, 248, 250, 252, and/or 254 desirably (e.g., suitably, efficiently, reliably, in an enhanced manner, and/or optimally) can be connected to a common bus 272 (e.g., a single common bus) that can be associated with an application, a system, and/or a device, to facilitate communication of data, provision of power, provision of clock signals, grounding, and/or performance of other desired functions of the sensor component 200, application, system, and/or device, such as described herein. In accordance with various embodiments, the common bus 272 can comprise a data bus(es), control bus, address bus, power bus, clock bus, ground bus, and/or other desired bus. In certain embodiments, the data bus(es) can enable the communication of data (e.g., audio or other sensor data), control signals, and/or address signals, and in other embodiments, the common bus can have a data bus, control bus, and/or address bus that can perform respective functions. In some embodiments, the data bus(es) can enable communication of data, control signals, and/or address signals (e.g., address information for addressing, selecting, and/or configuring respective sensor elements) between the sensor component 200 and the application, system, and/or device; the power bus can enable power to be provided by the application, system, and/or device to the sensor component 200; the clock bus can enable clock signals to be communicated to the sensor component 200 by the application, system, or device; and the ground bus can enable desired grounding of the sensor component 200.

Accordingly, in some embodiments, the respective sensor elements 212, 214, 216, and 218 and the respective ASICs 220, 222, 224, and 226 desirably (e.g., suitably, efficiently, reliably, in an enhanced manner, and/or optimally) can be connected to, and/or can share, the common bus 272 via the single group of conductive terminals (e.g., single set of input/output (I/O) pads) comprising the respective conductive terminals 244, 246, 248, 250, 252, and/or 254, to facilitate desirable operation of the sensor component 200, wherein the common bus 272 can be connected to an application, another system (or another part of the system), or a device, such as described herein. In certain embodiments, the respective sensor elements 212, 214, 216, and 218 and/or the respective ASICs 220, 222, 224, and 226 can be individually and respectively addressable, selectable, configurable, and/or controllable based at least in part on address information, configuration information, control information, and/or other information that can be received by the respective sensor elements 212, 214, 216, and 218 and/or the respective ASICs 220, 222, 224, and 226, via the common bus 272, from the application, other system (or other part of the system), or device, and/or a user associated therewith.

In accordance with various embodiments, the sensor component 102, the common bus 272, and/or the application, other system, device, or user can utilize an audio interface (e.g., digital audio interface) and audio interface technology, such as SoundWire, pulse density modulation (PDM), Inter-IC Sound (I²S), and/or other desired audio interface and audio interface technology, that can enable the respective sensor elements 212, 214, 216, and 218 and/or the respective ASICs 220, 222, 224, and 226 to be individually and respectively addressable, selectable, configurable, and/or controllable using the common bus 272 and based at least in part on respective address information, respective configuration information, respective control information, and/or other respective information associated with and/or directed to (e.g., via the common bus 272) the respective sensor elements 212, 214, 216, and 218 and/or the respective ASICs 220, 222, 224, and 226.

As an example of individual addressability, configurability, and/or control, first address information, first control information, and/or first configuration information can be received by a first sensor component 212 and/or first ASIC 220, via the common bus 272, from the application, other system, or device, and/or the user associated therewith. The first sensor element 212 can be individually configured (e.g., can have parameters or settings selected or set, and/or can be otherwise configured) and/or controlled based at least in part on the first address information associated with the first sensor element 212 that can identify or select the first sensor element 212 and/or direct the first control information and/or the first configuration information to the first sensor element 212 and/or the first ASIC 220 associated therewith, and based at least in part on the first control information and/or the first configuration information that can indicate or specify the configuration that the first sensor element 212 (and/or the first ASIC 220) is to have and/or how operation of the first sensor element 212 (and/or the first ASIC 220) is to be controlled.

Similarly, second address information, second control information, and/or second configuration information can be received by a second sensor component 214 and/or second ASIC 222, via the common bus 272, from the application, other system, or device, and/or the user associated therewith. The second sensor element 214 can be individually configured and/or controlled based at least in part on the second address information associated with the second sensor element 214 that can identify or select the second sensor element 214 and/or direct the second control information and/or the second configuration information to the second sensor element 214 and/or the second ASIC 222 associated therewith, and based at least in part on the second control information and/or the second configuration information that can indicate or specify the configuration that the second sensor element 214 (and/or the second ASIC 222) is to have and/or how operation of the second sensor element 214 (and/or the second ASIC 222) is to be controlled.

In certain embodiments, the respective sensor elements 212, 214, 216, and 218 (e.g., configured as respective microphone elements) being on the single die 208, and the respective addressability, configurability, and/or control of the respective sensor elements 212, 214, 216, and 218, can be employed or leveraged to enhance SNR (or SINR) of the sensor component 200. For instance, the respective sensor elements 212, 214, 216, and 218 and/or the respective ASICs 220, 222, 224, and 226 can be configured and/or controlled to sum (e.g., perform digital audio signal summing of) the respective data signals (e.g., audio signals or other type of data signals) of the respective sensor elements 212, 214, 216, and 218 and/or correlate the respective data signals of the respective sensor elements 212, 214, 216, and 218, based at least in part on respective address information associated with the respective sensor elements 212, 214, 216, and 218, and respective configuration information and/or respective control information relating to (e.g., directed to) the respective sensor elements 212, 214, 216, and 218 and/or the respective ASICs 220, 222, 224, and 226, wherein the respective address information, the respective configuration information, and/or the respective control information can be received, via the common bus 272, by the respective sensor elements 212, 214, 216, and 218 and/or the respective ASICs 220, 222, 224, and 226 from the application, other system (or other part of the system), device, and/or user. For example, if desired, the respective sensor elements 212, 214, 216, and 218 can be connected, summed, and/or correlated to act as one (e.g., act as a single sensor). The respective address information can comprise first address information associated with the first sensor element 212 that can identify or select the first sensor element 212 and/or direct first control information and/or first configuration information to the first sensor element 212 and/or the first ASIC 220 associated therewith; second address information associated with the second sensor element 214 that can identify or select the second sensor element 214 and/or direct second control information and/or second configuration information to the second sensor element 214 and/or the second ASIC 222 associated therewith; third address information associated with the third sensor element 216 that can identify or select the third sensor element 216 and/or direct third control information and/or third configuration information to the third sensor element 216 and/or the third ASIC 224 associated therewith; and fourth address information associated with the fourth sensor element 218 that can identify or select the fourth sensor element 218 and/or direct fourth control information and/or fourth configuration information to the fourth sensor element 218 and/or the fourth ASIC 226 associated therewith.

In some embodiments, with the audio signals of sensor elements (e.g., configured as microphone elements) being summed and correlated, for every doubling of microphone elements of an array of microphone elements, SNR for the array of microphone elements can be enhanced or increased by approximately 3 dB. For instance, if the audio signals of two microphone elements are summed together and correlated, SNR for the array comprising the two microphone elements can be enhanced or increased by approximately 3 dB, as compared to the SNR for a single microphone element; and if the audio signals of four microphone elements are summed together and correlated, SNR for the array comprising the four microphone elements can be enhanced or increased by approximately 3 dB, as compared to the SNR for an array comprising two microphone elements that are summed together and correlated.

In certain embodiments, since the respective sensor elements 212, 214, 216, and 218 can be individually addressable, the respective sensor elements 212, 214, 216, and 218 can be configured and/or controlled respectively (e.g., differently), as desired. As a non-limiting example, three of the respective sensor elements 212, 214, and 216 (e.g., configured as microphone elements) and/or the respective ASICs 220, 222, and 224 associated therewith can be configured and/or controlled to be at normal voltage bias (V_{bias}) and to sum and/or correlate the respective data signals (e.g., audio signals or other type of data signals) of the three respective sensor elements 212, 214, and 216, based at least in part on respective address information associated with those three respective sensor elements 212, 214, and 216 (e.g., to respectively select the respective sensor elements), and respective configuration information and/or respective control information relating to (e.g., directed to, based at least in part on the respective address information) those three respective sensor elements 212, 214, and 216 and/or the respective ASICs 220, 222, and 224, wherein the respective address information, the respective configuration information, and/or the respective control information can be received, via the common bus 272, by the three respective sensor elements 212, 214, and 216 and/or the respective ASICs 220, 222, and 224 from the application, other system (or other part of the system), device, and/or user. Meanwhile, based at least in part on address information associated with the fourth sensor element 218, and configuration information and/or control information relating to (e.g., directed to, based at least in part on the address information) the fourth sensor element 218 and/or the associated ASIC 226, the fourth sensor element 218 (e.g., configured as a microphone element) and/or associated ASIC 226 can be configured and/or controlled to be at a low voltage bias (e.g., a low V_{bias} that can be lower than the normal V_{bias}), and not have its audio signal summed with the other three audio signals of the other three sensor elements 212, 214, and 216, in order to enable the sensor component 200 to catch high SPL transient signals without clipping (e.g., using the configured fourth sensor element 218), using desired channel-switching specifications (e.g., channel-switching intellectual property (IP) specifications), but at audio interface level (e.g., at SoundWire level). This respective configuration and/or control of the respective sensor elements can desirably enhance or increase SNR of the sensor component 200 (based at least in part on the summing of the audio signals of the three sensor elements 212, 214, and 216), and also desirably enhance catching of high SPL transient signals without clipping (e.g., can desirably enable higher SPL handling, using the configured fourth sensor element 218).

In some embodiments, the respective sensor elements can be switchable (e.g., dynamically and/or automatically switchable) such that, as desired, the application can be utilized to communicate, via the common bus 272, respective address information and respective control and/or configuration information (e.g., switching information) to one or more of the respective sensor elements 212, 214, 216, and/or 218, and the one or more of the respective ASICs 220, 222, 224, and/or 226, to switch (e.g., dynamically switch) between the fourth sensor element 218 (e.g., the “high SPL” sensor element) being active and the first, second, and third sensor elements 212, 214, and 216 (e.g., the “high SNR” sensor elements) being active in order to desirably capture the dynamic range of the acoustic (e.g., audio) signals present.

As still another non-limiting example, the respective sensor elements 212, 214, 216, and 218 and/or the respective ASICs 220, 222, 224, and 226 (e.g., each of the sensor element-ASIC combinations) can be uniquely and desirably trimmed for a number of desired purposes based at least in part on respective address information, respective configuration information, and/or respective control information associated with the respective sensor elements 212, 214, 216, and 218 and/or the respective ASICs 220, 222, 224, and 226 that can be received, via the common bus 272, from the application, other system (or other part of the system), device, and/or user. For instance, the respective sensor elements 212, 214, 216, and 218 (e.g., configured as microphone elements) and/or the respective ASICs 220, 222, 224, and 226 can have respective sensitivity parameters set to match or substantially match to cover a same or substantially same range of SPLs, or can have respective sensitivity parameters set to be different (or some of the sensitivity parameters for some of the sensor elements set to be different) to cover different ranges of SPLs based at least in part on respective address information, respective configuration information, and/or respective control information associated with the respective sensor elements 212, 214, 216, and 218 and/or the respective ASICs 220, 222, 224, and 226 that can be received, via the common bus 272, from the application, other system (or other part of the system), device, and/or user. For example, the respective sensor elements 212, 214, and 216 (e.g., configured as microphone elements) and/or the respective ASICs 220, 222, and 224 associated therewith can be configured and/or controlled to have the three sensor elements 212, 214, and 216 be at a first sensitivity parameter value(s) (e.g., at the same or substantially similar sensitivity parameter values), based at least in part on respective address information associated with those three respective sensor elements 212, 214, and 216 (e.g., to respectively select the respective sensor elements), and respective configuration information and/or respective control information relating to (e.g., directed to, based at least in part on the respective address information) those three respective sensor elements 212, 214, and 216 and/or the respective ASICs 220, 222, and 224, wherein the respective address information, the respective configuration information, and/or the respective control information can be received, via the common bus 272, by the three respective sensor elements 212, 214, and 216 and/or the respective ASICs 220, 222, and 224 from the application, other system (or other part of the system), device, and/or user, and wherein the first sensitivity parameter value(s) can enable those three respective sensor elements 212, 214, and 216 to have a relatively higher SNR and to be able to handle relatively lower SPL transient signals without clipping. Meanwhile, the fourth sensor element 218 (e.g., configured as a microphone element) and/or associated ASIC 226 can be configured and/or controlled to have the fourth sensor element 218 be at a second sensitivity parameter value based at least in part on address information associated with the fourth sensor element 218, and configuration information and/or control information relating to (e.g., directed to, based at least in part on the address information) the fourth sensor element 218 and/or the associated ASIC 226, wherein the address information, configuration information, and/or control information can be received, via the common bus 272, by the fourth sensor element 218 and/or the associated ASIC 226 from the application, other system (or other part of the system), device, and/or user, and wherein the second sensitivity parameter value can enable the fourth sensor element 218 to have a relatively lower SNR (e.g., lower than the SNR of the three respective sensor elements 212, 214, and 216) and to be able to handle relatively higher SPL transient signals without clipping (as compared to the three respective sensor elements 212, 214, and 216).

As yet another non-limiting example, beamforming-related parameter values of the respective sensor elements 212, 214, 216, and 218 and/or the respective ASICs 220, 222, 224, and 226 can be respectively (e.g., uniquely or differently) and desirably (e.g., suitably, efficiently, in an enhanced manner, and/or optimally) set or modified to achieve desirable respective beamforming of the respective sensor elements 212, 214, 216, and 218 based at least in part on respective address information, respective configuration information, and/or respective control information associated with the respective sensor elements 212, 214, 216, and 218 and/or the respective ASICs 220, 222, 224, and 226 that can be received, via the common bus 272, from the application, other system (or other part of the system), device, and/or user. For instance, to achieve desirable respective beamforming of the respective sensor elements 212, 214, 216, and 218, first beamforming-related parameter values of the first sensor element 212, and/or the first ASIC 220 can be desirably set or modified based at least in part on first address information, first configuration information, and/or first control information; second beamforming-related parameter values of the second sensor element 214, and/or the second ASIC 222 can be desirably set or modified based at least in part on second address information, second configuration information, and/or second control information; third beamforming-related parameter values of the third sensor element 216, and/or the third ASIC 224 can be desirably set or modified based at least in part on third address information, third configuration information, and/or third control information; and/or fourth beamforming-related parameter values of the fourth sensor element 218, and/or the fourth ASIC 226 can be desirably set or modified based at least in part on fourth address information, fourth configuration information, and/or fourth control information.

As still another non-limiting example, one or more of the ASICs (e.g., 220, 222, 224, and/or 226) can be configured to comprise components and circuitry that can enable one or more of the associated sensor elements (e.g., 212, 214, 216, and/or 218) to be switched or reconfigured from functioning as a microphone element to functioning as an electrostatic speaker (e.g., a loudspeaker) that can be used to facilitate performing an acoustic self-test of the sensor component 200. In some embodiments, with the sensor elements 212, 214, 216, and 218 sharing the same back volume of the sensor component 200, at least one sensor element (e.g., 218) can be configured as a speaker, based at least in part on the components and circuitry of at least one ASIC (e.g., 226) associated therewith, and the speaker can be driven to produce (e.g., generate and emit) a desirably (e.g., suitably or substantially) large pressure-field acoustic signal inside the package of the sensor component 200 that can readily (e.g., easily) be detectable by the other sensor elements (e.g., sensor elements 212, 214, and/or 216, which can be configured as microphone elements). The operation and functionality of the other sensor elements (e.g., sensor elements 212, 214, and/or 216) can be determined or measured based at least in part on the results of detection of large pressure-field acoustic signal (e.g., how well the large pressure-field acoustic signal has been detected) by the other sensor elements (e.g., sensor elements 212, 214, and/or 216). In certain embodiments, with regard to a four sensor element array, it can be desirable (e.g., wanted, useful, or necessary) to have two of the sensor element-ASIC pairs to be configured to enable two sensor elements (e.g., 216 and 218) to function as electrostatic speakers, and the other two sensor elements (e.g., 212 and 214) can be configured as microphone elements to enable or allow desirable acoustic self-test function (e.g., testing or measurement of acoustic sensing function) of each of the microphone elements.

As yet another non-limiting example, the respective sensor elements 212, 214, 216, and 218 and/or the respective ASICs 220, 222, 224, and 226 can be desirably (e.g., suitably, efficiently, in an enhanced manner, and/or optimally) designed, fabricated, and/or configured to enable or allow some ASIC connections to be shared between sensor elements (e.g., an ASIC connection of one ASIC can be shared by the sensor elements) and ASIC connections to be isolated (e.g., an ASIC connection of one ASIC can be used for one associated sensor element, and can be isolated from the other sensor elements). For instance, the respective sensor elements 212, 214, 216, and 218 and/or the respective ASICs 220, 222, 224, and 226 can be desirably (e.g., suitably, efficiently, in an enhanced manner, and/or optimally) designed, fabricated, and/or configured to enable one ASIC (e.g., ASIC 220) to provide a single voltage bias (V_{bias}) connection, and thus, provide a single voltage bias (V_{bias}) via the single voltage bias connection, to all of the sensor elements 212, 214, 216, and 218 of the sensor component 200. Even though enabling one ASIC (e.g., ASIC 220) to provide a single voltage bias (V_{bias}) connection to all of the sensor elements can have a cost by not allowing for individual voltage bias control per sensor element, enabling one ASIC (e.g., ASIC 220) to provide a single voltage bias (V_{bias}) connection to all of the sensor elements 212, 214, 216, and 218 of the sensor component 200 enable or allow a greater overall capacitance associated with the sensor elements 212, 214, 216, and 218 that can improve low-frequency noise filtering of the voltage bias charge pump and an analog front end (AFE) of the sensor component 200, as compared to capacitance associated with a single sensor element. For example, with regard to the sensor component 200 (e.g., when configured as a microphone), the larger MEMS capacitance can facilitate (e.g., aid, help, enable, and/or benefit) reducing the noise of the ASIC charge pump and front-end circuitry that interface to the MEMS backplate and MEMS diaphragm signals, respectively. This improved low-frequency noise filtering can lead to or result in overall SNR of each of the sensor elements 212, 214, 216, and 218 being improved, as compared to the SNR that can be achieved when the respective sensor elements have individual voltage bias (V_{bias}) connections with the respective ASICs 220, 222, 224, and 226.

As still another non-limiting example, one or more of the ASICs (e.g., ASIC 224 and/or ASIC 226) can be designed, fabricated, and/or configured to be one or more analog ASICs that can be associated and utilized with one or more sensor elements (e.g., sensor element 216 and/or sensor element 218). In some embodiments, in the multi-sensor element array of the sensor component 200, having an ASIC(s) be an analog ASIC(s) can be desirable (e.g., useful, beneficial, enhanced, and/or optimal) for ultra-low power applications where the low-power analog ASIC(s) (e.g., relatively lower powered analog ASIC(s)) can be utilized to wake up (e.g., transition from inactive or sleep state to an active or awake state) the digital ASICs (e.g., ASIC 220 and/or ASIC 222 (and/or ASIC 224)) and application processor (e.g., processor of or associated with the application (e.g., customer or user application, or other application). In certain embodiments, if individual or balanced analog audio can be preferred by the application (or associated user), rather than a digital audio format, one or more of the ASICs (e.g., ASIC 224 and/or ASIC 226) can be designed, fabricated, and/or configured to be one or more analog ASICs that can be associated and utilized with one or more sensor elements (e.g., sensor element 216 and/or sensor element 218) to enable the one or more sensor elements (e.g., 216 and/or 218) to produce analog audio signals based at least in part on sound (e.g., sound waves and/or SPLs) sensed by the one or more sensor elements.

With further regard to the lid component 206 of the sensor component 200, in some embodiments, the lid component 206 can be associated with (e.g., bonded, connected, or attached to, and/or placed on) the first layer 202 of the sensor component 200. In certain embodiments, the lid component 206 can be a housing that can comprise a top portion and sidewall portions (e.g., four sidewall portions associated with the top portion), and can have desired size and shape that can correspond to the size and shape of the first layer 202. For instance, respective dimensions (e.g., length and width) of the top portion and the sidewall portions of the lid component 206 can correspond to (e.g., can be same or substantially same as) the respective dimensions (e.g., length and width) of the first layer 202. In certain embodiments, the lid component 206 (e.g., the respective sidewall portions of the lid component 206) can have a desired height (e.g., a desirably large height) to enable the sensor component 200 to have a desirable back volume (e.g., a desirably large back volume or cavity), which can be the space in the enclosure that can be formed by connecting the lid component 206 to the first layer 202, and which can be shared by (e.g., associated with, utilized by, or available to) the group of sensor elements 210 (e.g., sensor elements 212, 214, 216, and 218, for example, configured as microphone elements). In some embodiments, the back volume of the sensor component 200 can be desirably (e.g., significantly, suitably, efficiently, in an enhanced manner, and/or optimally) larger than the relatively smaller size back volume that may be able to be used (e.g., while providing or maintaining desirable sensor characteristics, such as SNR, AOP, resonance, acoustic-mass loading, and/or other sensor characteristics) for existing sensor components (e.g., existing microphones) that have a single sensor element or have multiple sensor elements with each of the sensor elements being on separate (e.g., diced) dies. For example, the larger back volume that can be utilized for the sensor component 200 due in part to the use of multiple sensor elements (e.g., 212, 214, 216, and 218) on the single die 208, as compared to the relatively smaller back volumes that can be utilized for existing sensor components, can enable package noise of the sensor package of the sensor component 200 to be desirably (e.g., suitably, efficiently, in an enhanced manner, and/or optimally) mitigated (e.g., can enable the package noise to effectively be eliminated, minimized, or reduced) and to enable the size of the back volume of the sensor component 200 to be desirably unlimited or at least virtually unlimited (e.g., at least with regard to how the size of the back volume impacts or changes the amount of package noise of the sensor component).

In some embodiments, to facilitate sensing of conditions (e.g., sound waves, and/or SPLs and/or amplitudes of sound waves) by the respective sensor elements 212, 214, 216, and 218 (e.g., configured as microphone elements) of the sensor component 200, a sound port 274 (e.g., an acoustic port or opening) of a desired size and shape can be formed in (e.g., cut into) the second layer 204 and the other layers of the stack of layers of the multi-layer component of the sensor component 200 (e.g., to enable the sensor elements 212, 214, 216, and 218 to be exposed to the outside environment (e.g., to sound waves or other conditions in the environment outside of the sensor component 200) via the sound port 274), wherein the group of sensor elements 210 (e.g., sensor elements 212, 214, 216, and 218) can be situated over or in proximity to (e.g., within a defined distance of) the sound port 274. In certain embodiments, the lid component 206 can be constructed of a desired metal material (e.g., aluminum, steel, or other desired metal material) or non-metal material. In some embodiments, the sound port 274 can be desirably shared by (e.g., associated with, utilized by, or available to) the group of sensor elements 210 (e.g., sensor elements 212, 214, 216, and 218). In certain embodiments, the sound port 274 can be a desirably (e.g., suitably, in an enhanced manner, and/or optimally) large sound port that can have a desirably large size (e.g., length and width) and shape (e.g., square or rectangular, or substantially square or rectangular, shape) that can correspond to the size and shape of the single die 208 to enable the respective sensor elements 212, 214, 216, and 218 to be exposed to the environment outside of the sensor component 200 and sense conditions (e.g., sound waves and/or pressure, and/or other conditions) of the outside environment via the sound port 274. In some embodiments, the sound port 274 (e.g., a single larger sound port) can be desirably (e.g., significantly, suitably, efficiently, in an enhanced manner, and/or optimally) larger than the relatively smaller size (e.g., smaller diameter) of a sound port that may be able to be used (e.g., while providing or maintaining desirable sensor characteristics, such as SNR, AOP, resonance, acoustic-mass loading, and/or other sensor characteristics) for existing sensor components (e.g., existing microphones) that have a single sensor element or have multiple sensor elements with each of the sensor elements being on separate (e.g., diced) dies. For instance, the larger sound port 274 can desirably (e.g., suitably, efficiently, in an enhanced manner, and/or optimally) mitigate (e.g., avoid, reduce, or minimize) front-cavity resonance of the sensor component 200, enhance the geometry of the sound port 274, and preserve high frequency of resonance, which can allow enhanced (e.g., better) high-frequency AOP without increasing backplate resistance of the sensor component 200. With each of the multiple sensor elements (e.g., 212, 214, 216, and 218) of the sensor element array sharing the same larger sound port 274, each sensor element can achieve a desirably flatter frequency response through the audio band, while maintaining the resonant frequency to be desirably high.

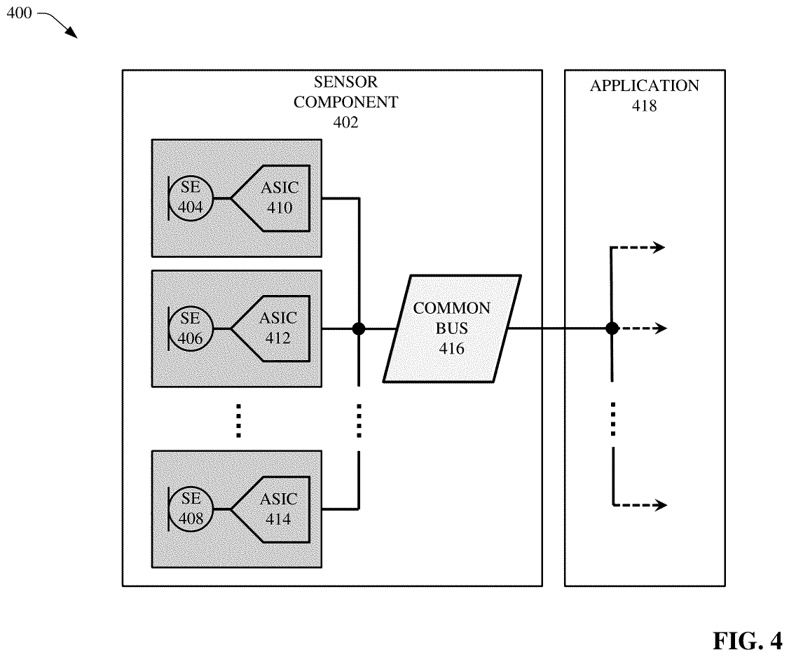

Referring to FIG. 4 (along with FIGS. 1-3), FIG. 4 illustrates a diagram of a non-limiting example system 400 that can desirably (e.g., suitably, efficiently, reliably, in an enhanced manner, and/or optimally) comprise a multi-sensor element arrangement comprising multiple sensor elements on a single die, wherein the sensor elements and associated circuitry (e.g., ASICs) can be associated with a common bus and an application, in accordance with various aspects and embodiments of the disclosed subject matter. In some embodiments, the system 400 can comprise a sensor component 402 that can be in a single sensor package (e.g., sensor device). In accordance with various embodiments, the sensor component 402 can comprise a desired number (n) of sensor elements, comprising sensor element 404, sensor element 406, and up through sensor element 408, and a desired number of ASICs, comprising ASIC 410, ASIC 412, and up through ASIC 414, that can be associated with the sensor elements (e.g., 404, 406, and/or 408), respectively. In some embodiments, the respective sensor elements (e.g., 404, 406, and/or 408) can be the same as or similar to, and can comprise the same or similar functionality as, sensor elements, such as have been described herein. In certain embodiments, the respective ASICs (e.g., 410, 412, and/or 414) can be the same as or similar to, and can comprise the same or similar functionality as, ASICs, such as have been described herein.

In accordance with various embodiments, the sensor component 402 can comprise a lid component (not shown in FIG. 4; as described herein) that can be a housing or part of the housing of the sensor component 402, the multi-layer component comprising a desired number of layers, a sound port (not shown in FIG. 4; as described herein), and I/O pads (e.g., conductive terminals) (not shown in FIG. 4; as described herein) that can be on the bottom layer of the multi-layer component, wherein the sensor elements (e.g., 404, 406, and/or 408) and ASICs (e.g., 410, 412, and/or 414) can be associated with (e.g., attached, bonded, or connected to) the top layer of the multi-layer component, and wherein the sensor elements (e.g., 404, 406, and/or 408) can be exposed to the outside environment (e.g., can be exposed to sound waves or other conditions in the environment outside of the sensor component 402) via the sound port, such as described herein. In certain embodiments, the sensor elements (e.g., 404, 406, and/or 408) can be MEMs sensors (e.g., MEMS microphones or other type of sensor). The lid component can be associated with (e.g., attached to) the top layer of the multi-layer component, which can create a back volume (e.g., back cavity; an internal or closed (or substantially closed) space) in the sensor component 402. In accordance with various embodiments, the respective sensor elements (e.g., 404, 406, and/or 408) desirably (e.g., suitably, efficiently, in an enhanced manner, and/or optimally) can share or utilize the same back volume, sound port (e.g., relatively larger sound port), and I/O pads.

In some embodiments, the respective ASICs (e.g., 410, 412, and/or 414), and the respective sensor elements (e.g., 404, 406, and/or 408) via the respective ASICs (e.g., 410, 412, and/or 414), can be connected to and can share the same common bus 416. In accordance with various embodiments, the common bus 416 can comprise a data bus(es), control bus, address bus, power bus, clock bus, ground bus, and/or other desired bus that can be utilized to communicate respective signals (e.g., data, control, address, clock, and/or other signals), provide power, and/or provide the ground, such as described herein. In some embodiments, the system 400 can comprise an application 418 that can be associated with (e.g., communicatively and/or electronically connected to) the common bus 416, and the respective conductive terminals of the multi-layer component of the sensor component 402 that can be associated with the common bus 416, and the respective sensor elements (e.g., 404, 406, and/or 408) and the respective ASICs (e.g., 410, 412, and/or 414) can be associated with (e.g., communicatively and/or electronically connected to) the application 418 via the common bus 416 and the respective conductive terminals of the multi-layer component of the sensor component 402. In certain embodiments, the application 418 can be utilized by a user (e.g., consumer, technician, or other user) to interact with, control, configure, process information received from, and/or exchange information with the sensor component 102 (the respective sensor elements and/or the respective ASICs of the sensor component 102), such as described herein. For instance, the application 418 can be utilized to process data signals (e.g., audio signals and/or other sensor data) received from the sensor component 102 via the common bus 416.

In some embodiments, the application 418 can be utilized to individually and respectively address, configure (e.g., configure parameters or settings), and/or control operation of the respective sensor elements (e.g., 404, 406, and/or 408) based at least in part on respective address signals, respective configuration data signals, respective control signals, respective clock signals, and/or other respective signals communicated by the application 418 to the respective sensor elements (e.g., 404, 406, and/or 408) and/or the respective ASICs (e.g., 410, 412, and/or 414) via the common bus 416, such as described herein. As some non-limiting examples, the application 418 can be utilized to individually and respectively address, configure (e.g., configure parameters or settings), and/or control operation of the respective sensor elements (e.g., 404, 406, and/or 408), based at least in part on the respective signals, to sum and correlate the signals of two or more sensor elements together, to configure or set respective voltage biases and/or other parameters for the respective sensor elements, to respectively and uniquely trim and/or set the sensitivities of respective sensor elements and/or ASICs to cover respective ranges of SPLs, to achieve desired beamforming of the respective sensor elements, to achieve desired dynamic range extension of the respective sensor elements, to perform an acoustic self-test of the sensor elements, to respectively configure and/or control the respective sensor elements and/or the respective ASICs for other desired purposes, and/or to achieve other desired functionality and operation of the respective sensor elements and/or ASICs, such as described herein.

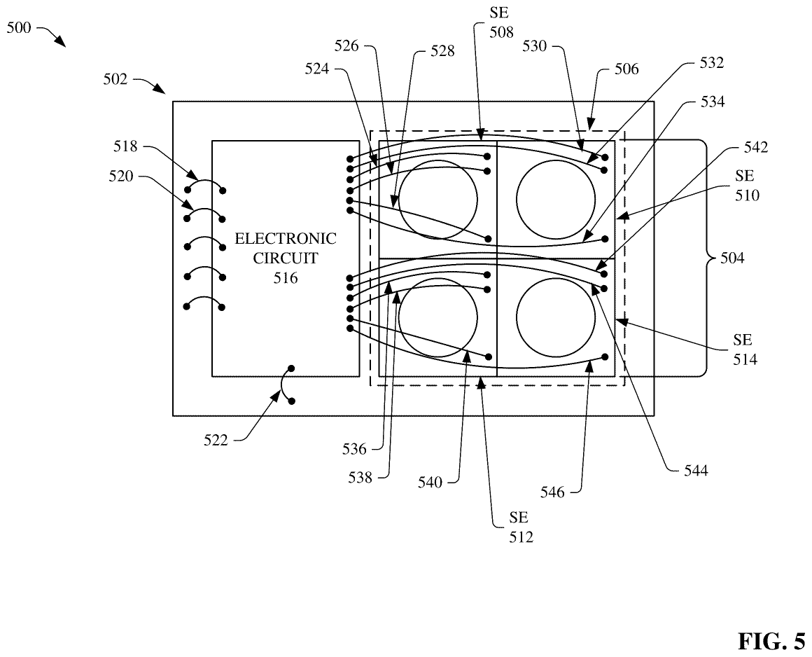

Referring to FIG. 5 (along with FIG. 1), FIG. 5 depicts a diagram of non-limiting example system 500 that can comprise a sensor component that can desirably (e.g., suitably, efficiently, reliably, in an enhanced manner, and/or optimally) comprise a multi-sensor element arrangement comprising multiple sensor elements on a single die, and an electronic circuit (e.g., an ASIC) that can be associated with the sensor elements, in accordance with various aspects and embodiments of the disclosed subject matter. In some embodiments, the system 500 can comprise a sensor component 502 that can comprise a group of sensor elements 504, which can comprise two or more sensor elements, formed, located, arranged, or contained on a single die 506, which can be attached to a top layer of a multi-layer component (only the top layer is shown in FIG. 5, for reasons of brevity and clarity). In certain embodiments, the group of sensor elements 504 can comprise four sensor elements, including sensor element 508, sensor element 510, sensor element 512, and sensor element 514, contained on the die 506 in the form of a sensor element array (e.g., a 2×2 sensor element array).

In certain embodiments, the sensor component can comprise a single electronic circuit 516 (e.g., a single ASIC) that can be associated with (e.g., electronically and/or communicatively connected to) the group of sensor elements 504. For instance, instead of each of the respective sensor elements (e.g., 508, 510, 512, and 514) being associated with a respective ASIC, all of the sensor elements (e.g., 508, 510, 512, and 514) of the group of sensor elements 504 can be associated with the same electronic circuit 516 (e.g., the same single ASIC).

In some embodiments, the sensor component 502 can be same as or similar to, and/or can comprise the same or similar functionality as, sensor components (e.g., 102 or 200), such as described herein. In certain embodiments, the electronic circuit 516 can comprise be same as or similar to, and/or can comprise the same or similar functionality as, electronic circuits (e.g., ICs or ASICs), such as described herein, although the electronic circuit 516 can be associated with (e.g., electronically and/or communicatively connected to) all four sensor elements (e.g., 508, 510, 512, and 514), rather than only one sensor element. In some embodiments, the electronic circuit 516 can have a desired number of wirebonds, including wirebonds 518, 520, and 522, that can connect the electronic circuit 516 to conductive via interconnects to facilitate connecting the electronic circuit 516 to the other layers (e.g., circuitry and/or terminals of the other layers), including the bottom layer (e.g., the respective conductive terminals of the bottom layer) of the multi-layer component of the sensor component 502. In certain embodiments, the electronic circuit 516 can have desired wirebonds that can connect the electronic circuit 516 to the respective sensor elements 508, 510, 512, and 514, wherein such wirebonds can comprise wirebonds 524, 526, and 528 between the electronic circuit 516 and the sensor element 508, wirebonds 530, 532, and 534 between the electronic circuit 516 and the sensor element 510, wirebonds 536, 538, and 540 between the electronic circuit 516 and the sensor element 512, and wirebonds 542, 544, and 546 between the electronic circuit 516 and the sensor element 514.

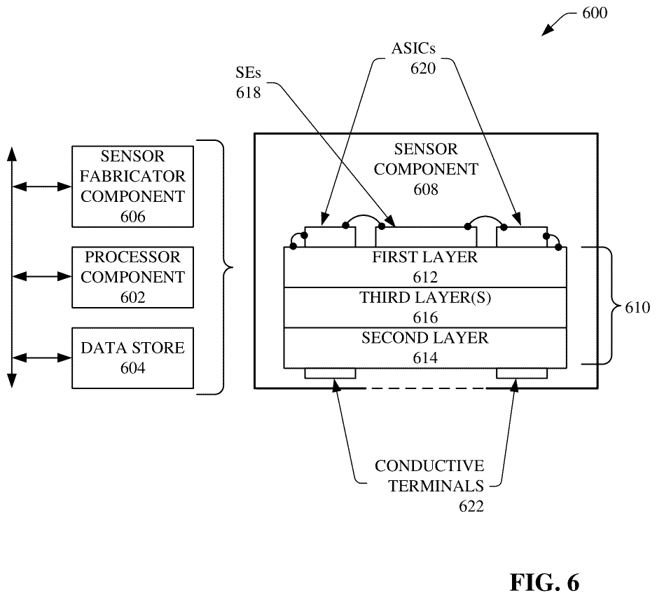

Referring to FIG. 6, FIG. 6 depicts a diagram of non-limiting example system 600 that can be utilized to create sensor components that each can comprise a multi-sensor element arrangement comprising multiple sensor elements on a single die, in accordance with various aspects and embodiments of the disclosed subject matter. In some embodiments, the system 600 can comprise a processor component 602 and a data store 604. In accordance with various embodiments, the processor component 602 can be associated with (e.g., communicatively connected to) or can comprise a sensor fabricator component 606 that can be utilized to create, form, fabricate, or design various components of or associated with a sensor component 608, including sensor elements, ASICs, and associated components and circuitry, such as more fully described herein. For instance, the sensor fabricator component 606 can be utilized to create, form, fabricate, or design the various components of the sensor component 608 that can be formed or situated on or in, or attached to, a multi-layer component 610 (e.g., multi-layer laminate component) that can comprise respective layers of non-conductive (e.g., insulator or dielectric), semiconductor, and/or conductive materials, such as described herein. In some embodiments, the respective layers of the multi-layer component 610 can comprise a first (e.g., top) layer 612, a second (e.g., bottom) layer 614, and at least one middle layer, such as third layer 616, that can be situated between and/or attached or connected to the first layer 612 and the second layer 614 in the stack of layers of the multi-layer component 610.

In certain embodiments, the sensor component 608 can comprise a group of sensor elements 618, comprising a desired number (e.g., 2, 4, 8, or more or less than 8) of sensor elements that can be formed or fabricated (e.g., by or using the sensor fabricator component 606) on a single die (e.g., single semiconductor die), wherein the single die can be attached (e.g., bonded or adhered) to the top surface of the first layer 612 using a desired bonding or adhesive material, or a fastener component(s). In some embodiments, the sensor component 608 can comprise a group of ASICs 620, comprising a desired number (e.g., 1, 2, 4, 8, or more or less than 8) of ASICs that can be formed or fabricated (e.g., by or using the sensor fabricator component 606) on, and/or can be attached (e.g., bonded or adhered) to, the first layer 612, and can be associated with (e.g., wirebonded or conductively connected to) the respective sensor elements of the group of sensor elements 618. Certain terminals of the respective ASICs can be associated with (e.g., wirebonded or conductively connected to) respective conductive via interconnects associated with the first layer 612 and one or more other layers (e.g., 614 and/or 616) of the multi-layer component 610 to facilitate connecting the respective ASICs to other components of the other layers of the multi-layer component 610. In some embodiments, the group of sensor elements 618 can comprise microphone elements that can comprise diaphragms, backplates, and other components. In certain other embodiments, the group of sensor elements 618 can comprise another type(s) of sensor that can be utilized to sense a desired type of condition(s). In some embodiments, the group of sensor elements 618 can be MEMS sensor elements and/or other components of the sensor component 608 can be MEMS components.

In certain embodiments, a group of conductive terminals 622, comprising a desired number (e.g., 4, 6, 8, or more or less than 8) of conductive terminals (e.g., conductive pads) can be formed or fabricated (e.g., by or using the sensor fabricator component 606) on the bottom surface of the second layer 614, such as described herein. In some embodiments, the respective conductive terminals of the group of conductive terminals 622 on the second layer 614 can be connected to the respective ASICs of the group of ASICs 620 on the first layer 612 (and accordingly, the group of sensor elements 618) using the conductive via interconnects and/or other components. In certain embodiments, the sensor fabricator component 606 can form or facilitate forming a sound port (not shown in FIG. 6 for reasons of brevity and clarity) in the multi-layer component 610, wherein the sound port can correspond to the location of the group of sensor elements 618 to enable the sensor elements to be exposed to the environment outside of the sensor component 608 to enable the sensor elements to sense conditions associated with or in proximity to the sensor component 608, such as described herein. In some embodiments, the sensor fabricator component 606 can fabricate a common bus (not shown in FIG. 6 for reasons of brevity and clarity), or a portion thereof, and/or can facilitate connection of the group of terminals 622 to the common bus and/or interfacing of the group of terminals 622 to an application, system, or device that can be associated with (e.g., electronically and/or communicatively connected to) the common bus, such as described herein.

In accordance with various embodiments, the respective layers (e.g., 612, 614, and/or 616) of the multi-layer component 610 can comprise various other components that can comprise, for example, capacitors, resistors, switches, SCRs, transistors, inductors, diodes, electronic or conductive connectors, and/or other associated components and circuitry that can be respectively arranged and/or associated with (e.g., connected to) each other to form desired circuitry of the sensor component 608. In certain embodiments, such various components also can comprise a processor component (e.g., microcontroller, microprocessor, controller, processor, and/or other type of processing unit) and/or a memory component.

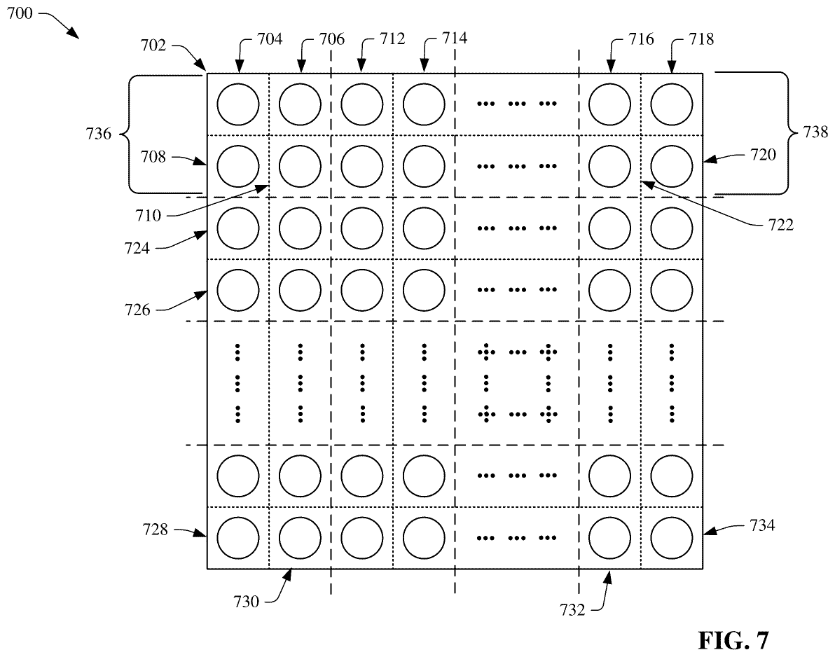

With further regard to the group of sensor elements 618 on the single die, referring briefly to FIG. 7 (along with FIGS. 1 and 6), FIG. 7 illustrates a diagram of a non-limiting example semiconductor wafer 700 that can comprise sensor elements that can be diced (e.g., cut, split, or separated) into respective groups (e.g., arrays) of sensor elements on respective single dies, in accordance with various aspects and embodiments of the disclosed subject matter. In some embodiments, the sensor fabricator component 606 can create, form, or fabricate a larger group of sensor elements on a semiconductor wafer 702, wherein the larger group of sensor elements can comprise sensor elements 704, 706, 708, 710, 712, 714, 716, 718, 720, 722, 724, 726, 728, 730, 732, and 734 (and the other sensor elements of the larger group of sensor elements). In certain embodiments, the sensor fabricator component 606 can dice (e.g., cut, separate, or divide) the larger group of sensor elements on the semiconductor wafer 702 to create respective single dies (e.g., 736, 738) that can comprise respective groups of sensor elements that each can comprise respective numbers (e.g., 2, 4, 8, or more or less than 8) of sensor elements. For example, the sensor fabricator component 606 can dice the larger group of sensor elements on the semiconductor wafer 702 to create respective single dies, comprising the first die 736, a second die 738, and one or more other dies, wherein the first die 736 can comprise a first group of sensor elements (e.g., the group of sensor elements 718), the second die 738 can comprise a second group of sensor elements, and another die(s) can comprise another group(s) of sensor elements, wherein the first group of sensor elements can comprise the sensor elements 704, 706, 708, and 710, and wherein the second group of sensor elements can comprise the sensor elements 716, 718, 720, and 722.

In some embodiments, as part of and to facilitate creating, forming, fabricating, or designing the various components of or associated with the sensor component 608, the sensor fabricator component 606 can form or process substrates and handle wafers (e.g., the wafer 702). Also, as part of and to facilitate creating, forming, fabricating, or designing the various components and/or circuitry of or associated with the sensor component 608, the sensor fabricator component 606 also can form, deposit, remove (e.g., selectively remove or etch), pattern, or process materials, including silicon or silicon-based materials, metallization layers (e.g., copper, gold, silver, superconducting materials, or other desired conductive material), silicon-on-insulator (SOI) materials, or other materials of the sensor component 608.

For example, the sensor fabricator component 606 can employ and/or can control various processes, including fabrication processes, microfabrication processes, nanofabrication processes, material deposition processes (e.g., a chemical vapor deposition (CVD) process, physical vapor deposition (PVD) process, low pressure chemical vapor deposition (LPCVD) process, sputtering process, or other material deposition process), masking or photoresist processes, lithography processes, photolithography processes, electroplating processes, molding processes, chemical etching processes (e.g., reactive-ion etching (RIE) process, deep reactive ion etching (DRIE), a potassium hydroxide (KOH) etching process, isotropic etching process, wet etching process, and/or buffered etching process), other etching or removal processes, micromachining processes, epitaxial processes, patterning processes, planarization processes (e.g., chemical-mechanical planarization or polishing (CMP) process), SOI processes, component formation processes, and/or other desired processes to desirably form, deposit, remove (e.g., selectively remove or etch), pattern, or process materials to facilitate creating or forming the respective components or circuitry of the sensor component 608.

In accordance with various embodiments, the processor component 602 can work in conjunction with the other components (e.g., the data store 604, the sensor fabricator component 606, or another component) to facilitate performing the various functions of the system 600. The processor component 602 can employ one or more processors, microprocessors, controllers, or microcontrollers that can process data, such as information relating to designing, fabricating, or forming the components and circuitry of the sensor components, information relating to material deposition processes, material patterning processes, and material removal processes, and information relating to circuit design criteria, circuit design algorithms, traffic flows, policies, protocols, interfaces, tools, and/or other information, to facilitate operation of the system 600, as more fully disclosed herein, and control data flow between the system 600 and other components (e.g., computer components, computer, laptop computer, other computing or communication device, or network device) associated with (e.g., connected to) the system 600.

The data store 604 can store data structures (e.g., user data, metadata), code structure(s) (e.g., modules, objects, hashes, classes, procedures) or instructions, information relating to designing, fabricating, or forming the components and circuitry of the sensor components, information relating to material deposition processes, material patterning processes, and material removal processes, and information relating to circuit design criteria, circuit design algorithms, traffic flows, policies, protocols, interfaces, tools, and/or other information, to facilitate controlling operations associated with the system 600. In an aspect, the processor component 602 can be functionally coupled (e.g., through a memory bus) to the data store 604 in order to store and retrieve information desired to operate and/or confer functionality, at least in part, to the data store 604, the sensor fabricator component 606, or other component, and/or substantially any other operational aspects of the system 600.

It should be appreciated that the data store 604 described herein can comprise volatile memory and/or nonvolatile memory. By way of example and not limitation, nonvolatile memory can comprise read only memory (ROM), programmable ROM (PROM), electrically programmable ROM (EPROM), electrically erasable ROM (EEPROM), nonvolatile quantum memory, and/or flash memory. Volatile memory can comprise random access memory (RAM) or volatile quantum memory, which can act as external cache memory and/or other type of memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), and/or other desired form volatile memory. Memory of the disclosed aspects are intended to comprise, without being limited to, these and other suitable types of memory.

In accordance with various embodiments, a system (e.g., the system 100, system 400, system 500, system 600, or other system) as disclosed herein, electronic components of such system, and/or one or more other electronic components or other systems associated with such system, and/or electronic circuitry relating thereto, can be formed in or on one or more ICs, one or more IC chips, and/or one or more dies. For example, such a system as disclosed herein can be formed on a single die, or portions of such system can be formed on a desired number of dies that can be associated with (e.g., electrically connected) to each other. In some embodiments, such a system as disclosed herein, or a desired portion thereof, can be, can comprise, and/or can be formed as or part of an ASIC.

It is to be appreciated and understood that one or more components (e.g., the sensor component, sensor element, electronic circuit, ASIC, multi-layer component, application, common bus, sensor fabrication component, processor component, data store, or other components) of the systems (e.g., the system 100, system 400, system 500, system 600, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned devices and/or systems have been described with respect to interaction between several components. It should be appreciated that such systems and components can include those components or sub-components specified therein, some of the specified components or sub-components, and/or additional components. Sub-components could also be implemented as components coupled to and/or communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

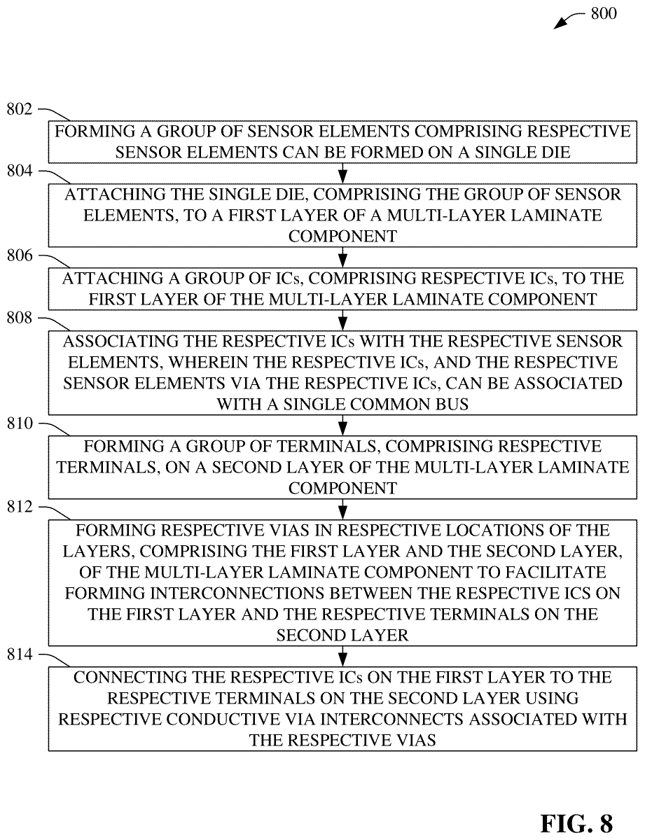

In view of the example systems and/or devices described herein, example methods that can be implemented in accordance with the disclosed subject matter can be further appreciated with reference to flowchart in FIG. 8. FIG. 8 illustrates methods and/or flow diagrams in accordance with the disclosed subject matter. For simplicity of explanation, the methods are depicted and described as a series of acts. It is to be understood and appreciated that the subject disclosure is not limited by the acts illustrated and/or by the order of acts, for example acts can occur in various orders and/or concurrently, and with other acts not presented and described herein. Furthermore, not all illustrated acts may be required to implement the methods in accordance with the disclosed subject matter.

Referring to FIG. 8, depicted is a flow diagram of an example method 800 that can desirably (e.g., suitably, efficiently, reliably, in an enhanced manner, and/or optimally) create (e.g., fabricate, form, or generate) a sensor component comprise a multi-sensor element arrangement that can comprise multiple sensor elements on a single die, in accordance with various aspects and embodiments of the disclosed subject matter. The method 800 can be implemented, for example, by or utilizing a system comprising the sensor fabricator component, at least one processor, and/or at least one memory (e.g., data store), such as described herein.

At 802, a group of sensor elements comprising respective sensor elements can be formed on a single die. In some embodiments, the sensor fabricator component can form the group of sensor elements comprising the respective sensor elements (e.g., two or more sensor elements) on the single die (e.g., single semiconductor die). For instance, the sensor fabricator component can fabricate a larger group of sensor elements on a larger die, and can dice (e.g., cut) the larger die (e.g., a semiconductor wafer) into a desired number of dies, wherein each of the dies can comprise a group of sensor elements that can comprise two or more sensor elements.

At 804, the single die, comprising the group of sensor elements, can be attached to a first layer of a multi-layer laminate component. In some embodiments, the sensor fabricator component can attach (e.g., bond) the single die, comprising the group of sensor elements, to the first layer (e.g., a top or outward facing surface of a top layer) of the multi-layer laminate component.

At 806, a group of ICs, comprising respective ICs, can be attached to the first layer of the multi-layer laminate component. In certain embodiments, the sensor fabricator component can attach (e.g., bond) the respective ICs (e.g., respective ASICs), to the first layer (e.g., the top surface of the top layer) of the multi-layer laminate component in proximity to (e.g., within a desired distance of) the respective sensor elements.

At 808, the respective ICs can be associated with the respective sensor elements, wherein the respective ICs, and the respective sensor elements via the respective ICs, can be associated with a single common bus. For instance, the sensor fabricator component can associate (e.g., can respectively bond via respective bond wires) the respective ICs to the respective sensor elements to form conductive and/or communicative connections between the respective ICs and the respective sensor elements (e.g., the respective diaphragms, respective back plates, and/or other respective components of the sensor elements).

At 810, a group of terminals, comprising respective terminals, can be formed on a second layer of the multi-layer laminate component. In some embodiments, the sensor fabricator component can form the respective terminals (e.g., respective conductive terminals or pads) on respective locations of the second layer (e.g., a bottom or outward facing surface of a bottom layer) of the multi-layer laminate component, wherein the multi-layer laminate component can comprise the first layer, the second layer, and/or one or more middle layers that can be situated between the first layer and the second layer.

At 812, respective vias can be formed in respective locations of the layers, comprising the first layer and the second layer, of the multi-layer laminate component to facilitate forming interconnections between the respective ICs on the first layer and the respective terminals on the second layer. In certain embodiments, the sensor fabricator component can form (e.g., drill) the respective vias in the respective locations of the layers, comprising the first layer and the second layer, of the multi-layer laminate component to facilitate forming interconnections between the respective ICs on the first layer and the respective terminals on the second layer.

At 814, the respective ICs on the first layer can be connected to the respective terminals on the second layer using respective conductive via interconnects associated with the respective vias. In some embodiments, the sensor fabricator component can form the respective conductive via interconnects (e.g., respective conductive vias) in the respective vias, and can connect the respective ICs (e.g., respective terminals of the respective ICs) on the first layer to the respective terminals on the second layer using the respective conductive via interconnects associated with the respective vias, wherein the respective ICs (e.g., the respective terminals of the respective ICs) can be connected to the respective conductive via interconnects using respective bond wires. It is to be appreciated and understood that other sensor fabrication processes and operations (e.g., forming a sound port in the multi-layer component, attaching a lid component to the first layer (and/or other layer), forming certain electronic circuitry of the middle layer(s), and/or other sensor fabrication processes and operations), including various processes and operations, such as described herein, can be performed (e.g., by the sensor fabricator component and/or other component or device) as part of fabricating or forming the sensor component, but for reasons of brevity and clarity, such other sensor fabrication processes and operations are not explicitly described in detail in respective operations (e.g., respective operations associated with respective reference numerals) with regard to the method 800.

It is to be appreciated and understood that components (e.g., sensor component, sensor element, electronic circuit, ASIC, die, layers, multi-layer component, terminals, wirebonds, vias, conductive via interconnects, common bus, application, processor component, data store, or other component), as described with regard to a particular system, device, or method, can comprise the same or similar functionality as respective components (e.g., respectively named components or similarly named components) as described with regard to other devices, systems, or methods disclosed herein.

Although the description has been provided with respect to particular embodiments thereof, these particular embodiments are merely illustrative and not restrictive.

While particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

In accordance with various embodiments, the sensor component, such as described herein, can comprise or can be associated with (e.g., communicatively and/or electronically connected to) and utilize a processor component and a data store. In some embodiments the processor component can work in conjunction with the other components of the sensor component to facilitate performing the various functions of the sensor component. The processor component can employ one or more microcontrollers, microprocessors, controllers, or processors that can process data, such as information relating to sensed conditions, sensor signals, respective parameter values of certain of the components (e.g., the sensor elements, the ASICs, or other components) of the sensor component, code, policies and rules, traffic flows, signaling, algorithms (e.g., algorithms as disclosed, defined, recited, or indicated herein by the methods, systems, and techniques described herein), protocols, interfaces, tools, and/or other information, to facilitate operation of the sensor component, as more fully disclosed herein, and control data or signal flow between the respective electronic components of the sensor component, and/or between the electronic components of the sensor component 102 and other electronic components or devices (e.g., devices (e.g., computer, mobile, and/or communication device), amplifier component(s), or other components) associated with the sensor component 102, and/or between the electronic components of the sensor component 102 and applications associated with the sensor component 102.

With further regard to the data store, the data store can store data structures (e.g., user data, metadata), code structure(s) (e.g., modules, objects, hashes, classes, procedures) or instructions, information relating to the sensed conditions, sensor signals, respective parameter values of certain of the components (e.g., the sensor elements, the ASICs, or other components) of the sensor component, code, policies and rules, traffic flows, signaling, algorithms (e.g., algorithms as disclosed, defined, recited, or indicated herein by the methods, systems, and techniques described herein), protocols, interfaces, tools, and/or other information, to facilitate controlling operations associated with the sensor component. In an aspect, the processor component can be functionally coupled (e.g., through a memory bus) to the data store in order to store and retrieve information desired to operate and/or confer functionality, at least in part, to the sensor component and its components, and/or substantially any other operational aspects of the sensor component. The data store can comprise volatile and/or non-volatile memory, such as described herein.

As used in this application, the terms “component,” “system,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

What has been described above includes examples of aspects of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system, comprising:
a group of sensor elements comprising respective sensor elements formed on a single semiconductor die, wherein the group of sensor elements is configured to sense a condition; and
a group of integrated circuits comprising respective integrated circuits configured to be associated with the respective sensor elements, wherein the respective integrated circuits, and the respective sensor elements via the respective integrated circuits, are configured to be associated with a single common bus.

2. The system of claim 1, wherein the group of sensor elements are formed in a multiple-dimensional array of sensor elements formed on the single semiconductor die.

3. The system of claim 1, wherein the respective sensor elements are respective Microelectromechanical Systems (MEMS) microphone elements, wherein the respective microphone elements are configured to comprise respective diaphragms and respective backplates configured to be separated from the respective diaphragms by respective air gaps, and wherein the respective integrated circuits are configured to be respective application-specific integrated circuits (ASICs).

4. The system of claim 1, wherein the respective integrated circuits are configured to access power, a ground, data, control signals, input and output, or digital audio signals via the single common bus.

5. The system of claim 1, further comprising:
a multiple-layer component configured to comprise respective layers comprising a first layer and a second layer, wherein the respective sensor elements and the respective integrated circuits are bonded to the first layer, wherein the respective sensor elements are configured to be wire bonded to the respective integrated circuits, and wherein the respective layers are configured to have respective vias, and wherein each of the respective layers comprises one or more dielectric, insulating, semiconductor, and/or conductive materials; and
a group of terminals comprising respective terminals that are formed on the second layer, wherein the respective integrated circuits are connected to the respective terminals through respective conductive interconnects formed in the respective vias, and wherein the respective terminals comprise a ground terminal, a power terminal, a clock terminal, and a data terminal that are shared or accessible by the respective integrated circuits.

6. The system of claim 5, further comprising a sensor component configured to comprise the group of sensor elements, the group of integrated circuits, the multiple-layer component, the group of terminals, and a housing configured to be connected to the multiple-layer component, wherein the respective layers are configured to contain an acoustic port that corresponds to a location of the group of sensor elements, wherein the group of sensor elements share or utilize the acoustic port that is configured to enable sound waves associated with the sensor component to be sensed by the group of sensor elements, and wherein the acoustic port is configured to be larger in size than a smaller acoustic port that otherwise is able to be associated with a single sensor element, in accordance with a defined performance criterion.

7. The system of claim 6, wherein the single common bus is configured to comprise a single data bus, and wherein the respective sensor elements are configured to be individually addressable on the single data bus, wherein the respective sensor elements comprise at least one sensor element and at least one other sensor element, and wherein, based on respective addressing of the respective sensor elements on the single data bus, the at least one sensor element is configured to operate as at least one electrostatic speaker that is configured to produce at least one pressure-field acoustic signal that is detectable by the at least one other sensor element configured as at least one microphone element to enable testing of the at least one microphone element.

8. The system of claim 6, wherein the sensor component is or comprises at least one of Microelectromechanical Systems (MEMS) sensor, a microphone, a sound pressure sensor, a pressure sensor, an acoustic sensor, a capacitive sensor, or a piezo sensor.

9. The system of claim 1, wherein the single common bus is configured to comprise a single data bus, and wherein the respective sensor elements are configured to be individually addressable on the single data bus.

10. The system of claim 9, wherein the respective sensor elements are configured to have a same bias voltage and have respective data signals summed using the single data bus based on respective addressing of the respective sensor elements on the single data bus, and wherein the summation of the respective data signals using the single data bus increases a signal-to-noise ratio relative to a lower signal-to-noise ratio associated with a single sensor element.

11. The system of claim 9, wherein, based on respective addressing of the respective sensor elements on the single data bus, the respective sensor elements are configured to comprise at least two sensor elements configured to have a substantially same bias voltage and have respective data signals summed using the single data bus, and comprise another sensor element configured to have a lower bias voltage that is lower than the substantially same bias voltage of the at least two sensor elements, wherein the summation of the respective data signals of the at least two sensor elements using the single data bus increases a signal-to-noise ratio, and wherein the lower bias voltage of the other sensor element facilitates handling sound-pressure-level transient signals over a defined threshold sound pressure threshold level without clipping.

12. The system of claim 9, wherein the respective sensor elements are configured to have a defined beamforming based on respective addressing and respective parameters of the respective sensor elements on the single data bus.

13. The system of claim 9, wherein the respective sensor elements are configured to have a dynamic range extension having a defined dynamic range extension value based on respective addressing and respective parameters of the respective sensor elements on the single data bus.

14. The system of claim 9, wherein, based on respective addressing of the respective sensor elements on the single data bus, the respective integrated circuits are configured to have an integrated circuit of the respective integrated circuits communicate a signal to all of the respective sensor elements via a connection with the single common bus or the single data bus, and wherein other respective connections between the single common bus and the respective integrated circuits, and the respective sensor elements via the respective integrated circuits, are isolated from each other.

15. The system of claim 9, wherein the respective integrated circuits comprise at least one analog integrated circuit configured to be utilized with at least one sensor element of the respective sensor elements.

16. The system of claim 1, wherein the respective sensor elements are configured to be accessible and configurable by an application via the single common bus and the respective integrated circuits.

17. A sensor device, comprising:
a group of sensor elements comprising respective sensor elements contained on a single semiconductor die, wherein the group of sensor elements is configured to sense a condition; and
at least one application-specific integrated circuit (ASIC) configured to be associated with the respective sensor elements, wherein the at least one ASIC and the respective sensor elements, via the at least one ASIC, are configured to be associated with a single common bus.

18. The sensor device of claim 17, wherein the respective sensor elements are a contiguous multiple-dimensional array of sensor elements formed on the single semiconductor die.

19. The sensor device of claim 17, wherein the respective ASICs are configured to access power, a ground, data, control signals, input and output, or digital audio signals via the single common bus.

20. The sensor device of claim 17, further comprising:
a multiple-layer component configured to comprise respective layers comprising a first layer and a second layer, wherein the respective sensor elements and the respective ASICs are bonded to the first layer, wherein the respective sensor elements are configured to be wire bonded to the respective ASICs, wherein the respective layers are configured to have respective vias, and wherein each of the respective layers comprises one or more dielectric, insulating, semiconductor, and/or conductive materials; and
a group of conductive pads comprising respective conductive pads that are formed on the second layer, wherein the respective ASICs are connected to the respective conductive pads through respective conductive interconnects associated with the respective vias, and wherein the respective conductive pads comprise a ground pad, a power pad, a clock pad, and a data pad that are shared or accessible by the respective ASICs.

21. The sensor device of claim 17, wherein the single common bus is configured to comprise a single data bus, and wherein the respective sensor elements are configured to be individually addressable on the single data bus via the respective ASICs.

22. The sensor device of claim 21, wherein the respective sensor elements are configured to have a same or substantially the same sensitivity parameter value or a same or substantially the same bias voltage based on respective addressing of the respective sensor elements on the single data bus.

23. The sensor device of claim 21, wherein the respective sensor elements comprise a first sensor element, a second sensor element, and a third sensor element, wherein the first sensor element is configured to have a first sensitivity parameter value or a first bias voltage, the second sensor element is configured to have a second sensitivity parameter value or a second bias voltage that is same or substantially the same as the first sensitivity parameter value or the first bias voltage, respectively, and the third sensor element is configured to have a third sensitivity parameter value or a third bias voltage based on respective addressing of the respective sensor elements on the single data bus, wherein the third sensitivity parameter value results in a higher sensitivity than the first sensitivity parameter value and the second sensitivity parameter value, and wherein the third bias voltage is lower than the first bias voltage and the second bias voltage.

24. The sensor device of claim 17, wherein the respective sensor elements comprise at least one of Microelectromechanical Systems (MEMS) sensor, a microphone, a sound pressure sensor, a pressure sensor, an acoustic sensor, a capacitive sensor, or a piezo sensor.

25. A system, comprising:
a group of sensor elements comprising respective sensor elements contained on a single die, wherein the respective sensor elements are structured to form a multiple-dimensional array of sensor elements, and wherein the group of sensor elements is configured to sense a condition; and
at least one application-specific integrated circuit (ASIC) configured to be associated with the respective sensor elements, wherein the at least one ASIC and the respective sensor elements, via the at least one ASIC, are configured to be associated with a single common bus.

26. The system of claim 25, wherein the respective sensor elements are configured to be individually addressable on the single common bus.
